(19) United States
(12) Patent Application Publication
(10) Pub. No.: US 2014/0181958 A1
(43) Pub. Date: Jun. 26, 2014

(54) SECURE AND CONVENIENT AUTHENTICATION

(71) Applicant: CHRISTOPHER A. NOSACK, Hillsboro, OR (US)

(72) Inventor: CHRISTOPHER A. NOSACK, Hillsboro, OR (US)

(21) Appl. No.: 13/726,722

(22) Filed: Dec. 26, 2012

(51) Int. Cl. G06F 21/31

(52) U.S. Cl. CPC G06F 21/31
USPC 726/19

(57) ABSTRACT

The claimed subject matter provides an apparatus for facilitating no-look one-handed authentication. The apparatus includes logic to identify whether a user-manipulatable input is in one of a plurality of possible states for a time period, and authenticate a user based at least partially on identification that the user-manipulatable input is in the one of the plurality of possible states for the time period.

### TECHNICAL FIELD

One or more embodiments described herein generally relate to authentication methods and systems. In particular, one or more embodiments relate to secure and convenient authentication methods and systems that facilitate no-look, one-handed authentication.

### BACKGROUND

Users are typically authenticated before being granted access to use of computing devices, vehicles, doors, automated teller machines, and other types of apparatuses. For example, many such apparatuses require entry of a passkey, such as a password, passcode, or personal identification number (PIN), before access is granted. However, it can often be difficult to prevent surreptitious spying when entering a passkey. Moreover, a user may suffer from permanent impairments (e.g., poor vision, a missing limb or finger) or temporary impairments (e.g., a lack of focus due to engagement in other activities, such as driving) that can complicate entry of a passkey or even insertion of a physical key into a keyhole. In addition, authentication of mobile devices can create hazardous driving conditions because a user will typically take their eyes off the road and at least one hand off the steering wheel to enter a passkey while driving.

Other problems with typical authentication schemes exist, including the inconvenience and difficulty of remembering a complicated passkey and a limited ability to customize the security strength of a passkey. For example, for some users a four digit PIN is not secure enough while for other users it may be more than adequate. In addition, a password can be difficult to remember particularly when it is required to meet standard password strength tests. A fingerprint reader or other biometric authenticator can address some of the foregoing problems to some extent. However, a fingerprint reader is a relatively expensive solution that requires dedicated hardware and space, which is quite limited on certain apparatuses, such as mobile devices. Accordingly, there is a need for improved authentication methods and systems.

### BRIEF DESCRIPTION OF THE DRAWINGS

FIG. 1 is a schematic showing an illustrative apparatus that can implement an authentication method in accordance with the claimed subject matter;

FIG. 2 is a schematic showing a smart phone as an example form factor of the apparatus in accordance with the claimed subject matter;

FIG. 3 is a schematic showing an example pattern of time periods in which a button of the smart phone of FIG. 2 is sequentially held and released to input a passkey in accordance with the claimed subject matter;

FIG. 4 is a schematic showing another example pattern of time periods in which the button of the smart phone is sequentially held and released to input a passkey at a speed that is more rapid than that of the set of reference time periods in accordance with the claimed subject matter;

FIG. 5 is a schematic showing an embodiment of the smart phone in which a user-manipulatable input of an I/O module is a touchscreen on the smart phone in accordance with the claimed subject matter;

FIG. 6 is a schematic showing an embodiment of the smart phone in which the user-manipulatable input of the I/O module is a switch on the smart phone in accordance with the claimed subject matter;

FIG. 7 is a schematic showing an embodiment of the smart phone in which the user-manipulatable input of the I/O module is a tilt angle sensor, which is embedded within a housing of the smart phone in accordance with the claimed subject matter;

FIG. 8 is a schematic showing a doorknob as an example form factor of the apparatus in accordance with the claimed subject matter; and

FIG. 9 is a schematic showing a process flow diagram for a no-look one-handed authentication method in accordance with the claimed subject matter.

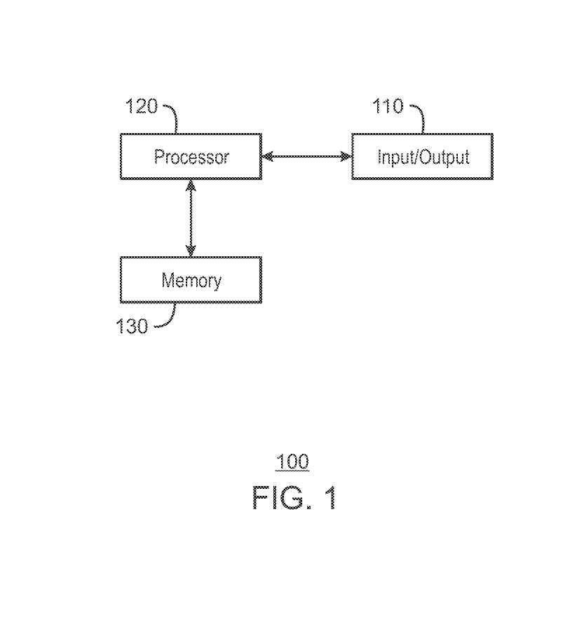

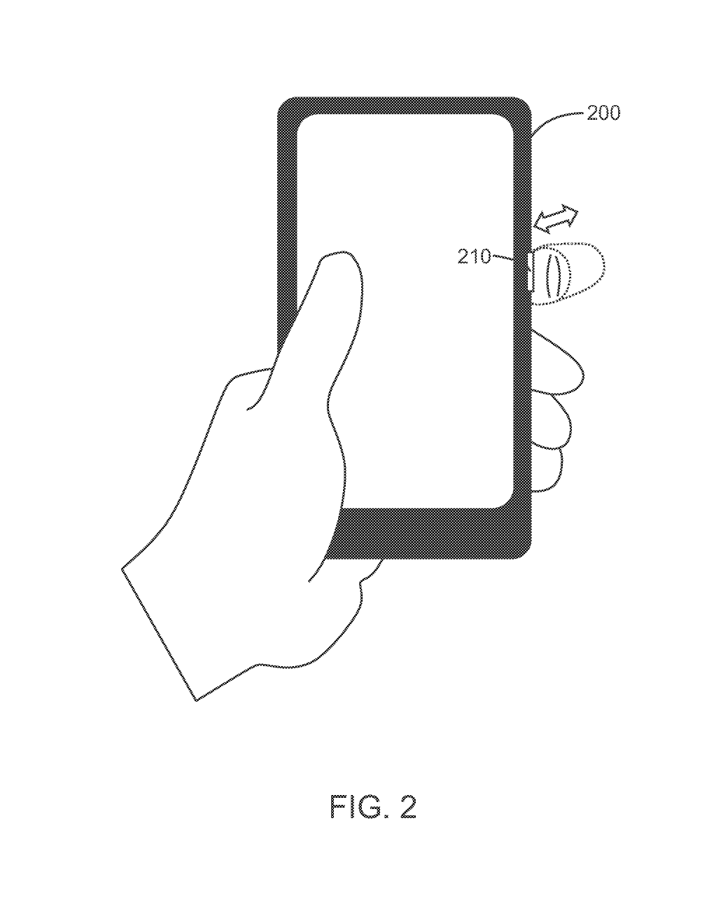

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, an embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement or order of features illustrated in the drawings or described herein need not be arranged in the particular way illustrated and described. Many other arrangements are possible according to some embodiments.

In each figure, elements may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

An example embodiment provides an apparatus and a method for facilitating one-handed authentication of a user of the apparatus. The apparatus can correspond to any device or object for which authentication is desirable to authorize use. For example, the apparatus may be any type of device, such as a smart phone or other type of portable communications device, a dedicated device, such as a book reader, a personal digital assistant (PDA), a laptop, a tablet, a netbook, a game device, a portable media system, an interface module, a desktop personal computer (PC), and so on. In addition, the apparatus can correspond to at least a portion of a door (e.g., a doorknob) providing access to a room or to a valuable object; a vehicle, such as a car, truck, or boat; or a financial transaction apparatus, such as an automated teller machine, an electronic point-of-sale system, or a cash register.

The authentication method, in one embodiment, includes measuring a series of consecutive time periods, each time period corresponding to a period during which a button, or other user-manipulatable input, on the apparatus is held down or a pause period between such button-holding time periods. The measured time periods are compared with a passkey comprising a series of reference values and, based on the comparison results, the user is or is not authenticated. The user of the apparatus, or an administrative operator associated with the user, may record the reference values during installation or when configuring settings of the apparatus. Thus, the passkey may be a sequence of holds and pauses that corresponds to the beat of a song that is known and easily recalled by the user.

By using hold and pause time periods to represent a passkey sequence, the authentication method facilitates entry of the passkey with one hand and without looking at the apparatus, i.e., no-look one-handed authentication, if desired. (The characterization of the authentication method as being a no-look one-handed authentication method is intended merely to highlight some possible benefits of the authentication method. Use of the authentication method does not necessarily prevent the user from looking or using both hands to enter the passkey.)

Accordingly, at least in certain embodiments, the button used to enter the passkey may be located at an inconspicuous part of the apparatus that is at least partially shielded from view (e.g., under a covering or on the underside of the apparatus), thereby reducing the likelihood of an observer learning the passkey. Alternatively, for apparatuses that fit in a pocket, the user can enter the passkey while the apparatus is hidden from view in the user's pocket, thereby reducing visibility of passkey entry. The button may be dedicated for passkey entry purposes or may be a softkey button that is used for other purposes, thereby preserving space and hardware on the apparatus that would otherwise be dedicated for authentication.

FIG. 1 is a schematic showing an illustrative apparatus 100 that can implement an authentication method. The apparatus 100 includes an input/output module 110, a processor 120, and a memory 130. The apparatus may be any type of computing device (e.g., a smart phone or other type of mobile telephone device, a dedicated device, such as a book reader, a PDA, a laptop, a tablet, a netbook, a game device, a portable media system, an interface module, a desktop PC, etc.); at least a portion of a door (e.g., a doorknob) providing access to a room or to a valuable object; a vehicle, such as a car, truck, or boat; or a financial transaction apparatus, such as an automated teller machine, an electronic point-of-sale system, or a cash register. Thus, in addition to the modules shown, the apparatus 100 may also include other components and modules (not shown) that carry out functions specific to the use of the apparatus.

A user interacts with the input/output module 110 to enter a passkey and receive feedback indicating whether the passkey matches a reference passkey. The input/output (I/O) module 110 includes a user-manipulatable input, such as a softkey or hardkey button, a key on a keyboard or pointing device (e.g., a mouse), a touchpad, a touchscreen, a switch, a tilt angle sensor (e.g., an accelerometer or gyroscope), or any other input capable of being manipulated by a user to be in various possible states. Examples of possible states include pressed and un-pressed (e.g., for a button), on and off (e.g., for a switch), tilted up and tilted down (e.g., for a tilt angle sensor), and the like. Moreover, the possible states that a user-manipulatable input may be in are not limited to two, but instead may be three or more in certain embodiments (e.g., an apparatus having a switch with three or more possible positions).

The I/O module 110 also includes an output providing feedback to the user as to the success or failure of passkey entry. The output may include a display, an LED, a speaker, a printer, etc. For example, when the passkey has been entered correctly, a display may so indicate to the user with text and/or graphics. In addition, when the passkey has not been entered correctly, the display may likewise represent to the user that the passkey entry attempt has failed. The I/O module 110 may also include an I/O device interface configured to connect the apparatus 100 to one or more user-manipulatable inputs or other I/O devices. The I/O devices may be built-in components of the apparatus 100, or may be devices that are externally connected to the apparatus 100 through wired or wireless connections.

The processor 120 is a general purpose processor that is capable of communicating with the input/output module 110 via a bus to receive the user-entered passkey and to transmit feedback to the user after carrying out a comparison of the user-entered passkey with a reference passkey. The processor 120 is also capable of communicating with the memory 130 to retrieve executable instructions and data via a dedicated bus. Additionally, the processor 120 can be a single core processor, a multi-core processor, a computing cluster, or any number of other configurations, and can include embedded logic and/or memory. Furthermore, the apparatus 100 may include more than one processor 120.

The memory 130 is a storage device that comprises a non-transitory computer-readable medium. The memory 130 stores data, including reference passkey data for access by the processor 120. In addition, the memory 130 stores instructions that are executable by the processor 120 to cause the apparatus to perform various operations, including the authentication operations described herein. The reference passkey data may include a set of reference values corresponding to reference time periods. As noted above, the reference values may be recorded during installation or when configuring settings of the smart phone 200. Moreover, in one embodiment the reference values may be re-configurable after an initial configuration stage to facilitate customization of the passkey or for other reasons.

The block diagram of FIG. 1 is not intended to indicate that the computing device 100 is to include all of the components shown in FIG. 1. Further, the computing device 100 may include any number of additional components not shown in FIG. 1, depending on the details of the specific implementation. For example, in one embodiment, the processor 120 is a thin client and the apparatus 100 includes an interface through which the processor 120 communicates with a remote server. Thus, the executable instructions and/or reference passkey data may be stored at the remote server and a processor at the remote server may carry out the authentication operations described herein.

FIG. 2 shows a smart phone 200 as an example form factor of the apparatus 100. The smart phone 200 includes a button 210 as an example user-manipulatable input that is part of the I/O module 110. The processor 120 and memory 130 are not shown but can be embedded within a housing of the smart phone 200. The button 210 is located on a longitudinal edge of the smart phone 200 in proximity to where a finger of a user rests when the smart phone is being held. (However, the depicted location of the button 210 is only one example location—other example locations include another edge of the smart phone 200, a region on the front planar portion of the smart phone 200, or a region on the back planar portion of the smart phone 200.) When a user desires to enter a passkey to unlock the smart phone 200, the user presses and releases the button 210 in a pattern of time periods that corresponds to a pre-programmed set of reference time periods, which are represented, for example, by a set of reference values stored in the memory 130. Logic in the processor 120 of the smart phone 200 identifies whether the pattern of button pressing and releasing time periods matches the pre-programmed set of reference time periods. This may be accomplished, for example, by measuring the time periods of the pattern entered by the user and comparing the measured time periods to the set of reference values. If the time periods sufficiently match up with the reference values the user is authenticated and the logic unlocks and grants the user access to the smart phone 200.

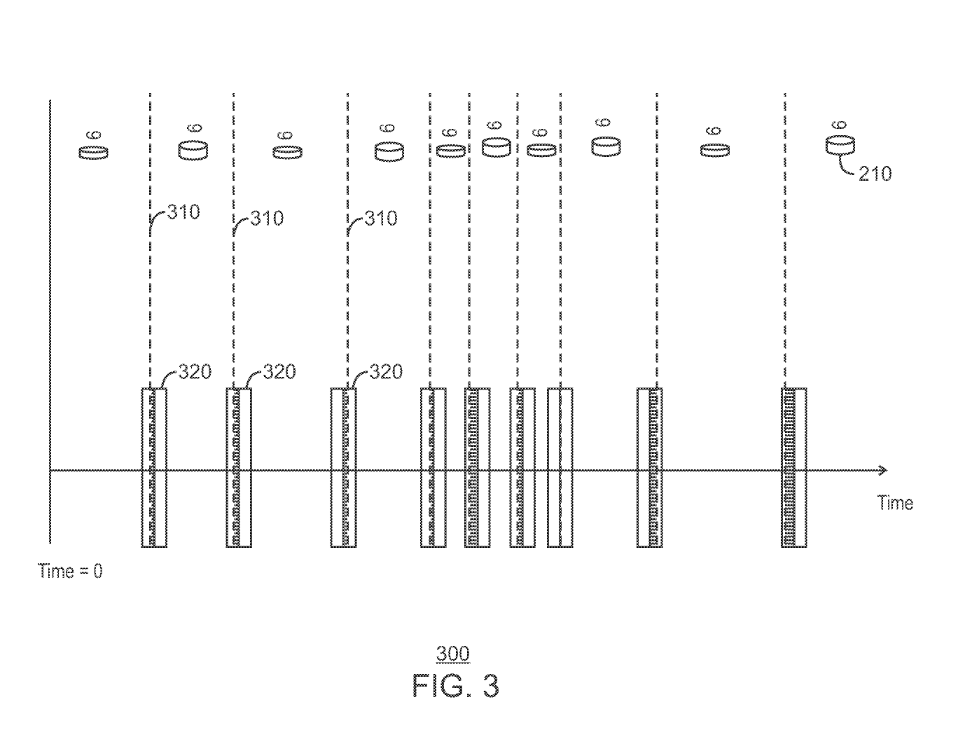

FIG. 3 is a schematic showing an example pattern of time periods in which the button 210 of the smart phone 200 is sequentially held and released to input a passkey. The boundaries 310 (indicated by dashed lines) mark boundaries between consecutive hold and release time periods. The boxed areas 320 represent the reference time periods (indicated by a line longitudinally bisecting the boxed areas 320) and tolerance limits that allow for human error in the passkey entry process. Thus, if the boundaries 310 of the user-entered passkey time periods lie outside the tolerance limits defined by the boxed areas 320 the passkey is considered improperly entered and the user is not authenticated. The tolerance limits may be pre-set and non-reconfigurable by a manufacturer of the apparatus. Alternatively, the logic of the processor 120 may facilitate reprogramming the tolerance limits by an administrative user responsible for a set of associated smart phones and/or by an end-user of the smart phone 200. Accordingly, tolerance for human error may be adapted to the different capabilities of different users and/or to adjust a strictness level of security for the authentication process.

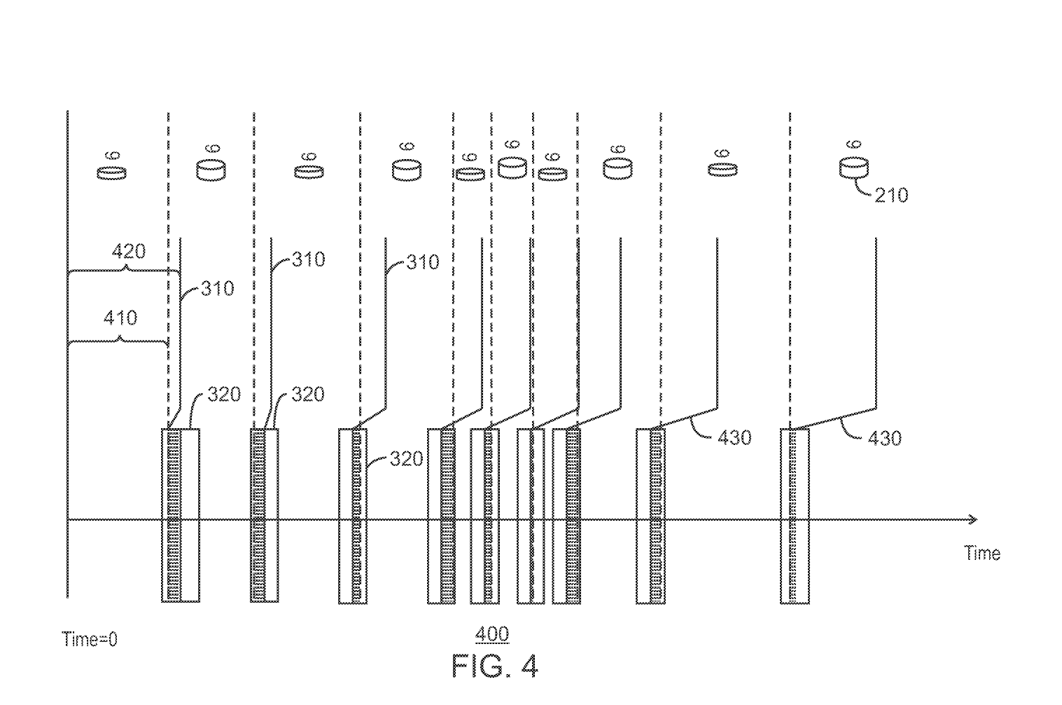

FIG. 4 is a schematic showing another example pattern of time periods in which the button 210 of the smart phone is sequentially held and released to input a passkey at a speed that is more rapid than that of the set of reference time periods. Alternatively, the passkey could have been entered too slowly. Either way, because the speed of the pattern can be difficult for a user to replicate precisely, the logic of the processor 120 in one embodiment makes allowances for a speed error. For example, the logic may automatically adjust the reference time periods and corresponding tolerance limits based on a difference between the initial measured time period 410 and the initial reference time period 420 so long as the initial measured time period 410 is within the initial tolerance limits of the boxed area 320 corresponding to the initial time period 420. For example, each reference time period subsequent to the first one may be increased or decreased in proportion to the ratio of the initial measured time period to the initial reference time period, as indicated by the diagonal lines 430.

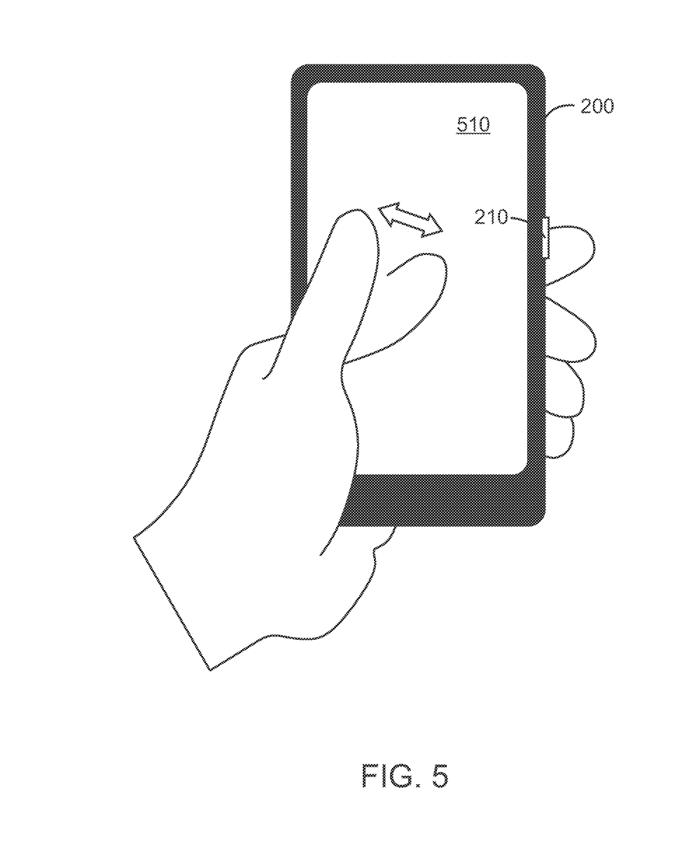

FIG. 5 shows an embodiment of the smart phone 200 in which the user-manipulatable input of the I/O module 110 is a touchscreen 510 on the smart phone 200. Thus, for example, instead of measuring time periods corresponding to manipulations of the button 210 of the smart phone 200, the logic of the processor 120 can measure time periods corresponding to manipulations of the touchscreen 500 to authenticate a user. In one embodiment, only a portion or a small number of portions of the touchscreen 500 is designated for entry of a passkey to enhance security.

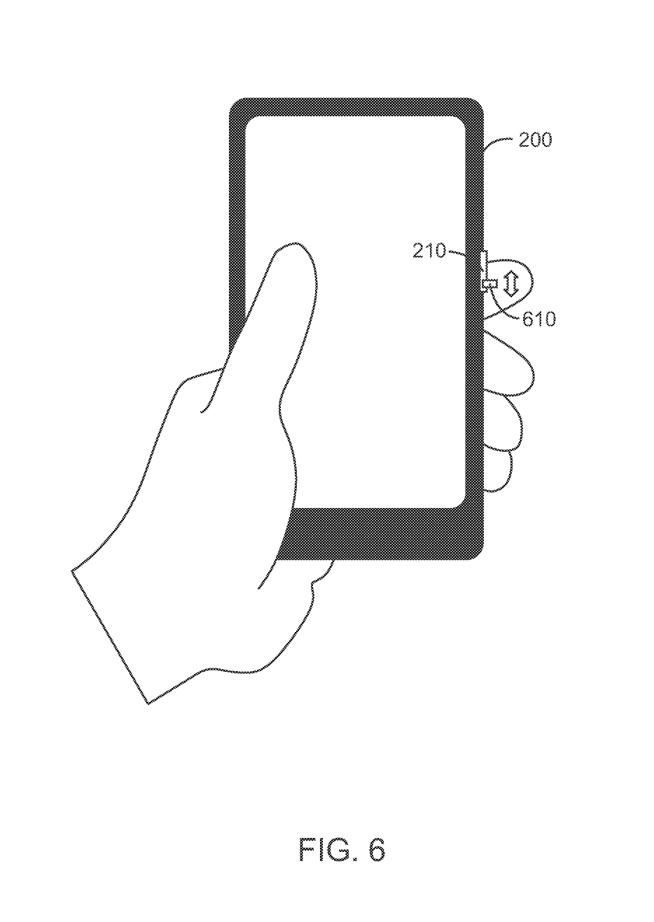

FIG. 6 shows an embodiment of the smart phone 200 in which the user-manipulatable input of the I/O module 110 is a switch 610 on the smart phone 200. Thus, for example, the logic of the processor 120 can measure time periods corresponding to manipulations of the switch 610 of the smart phone 200 for comparison with the stored reference values.

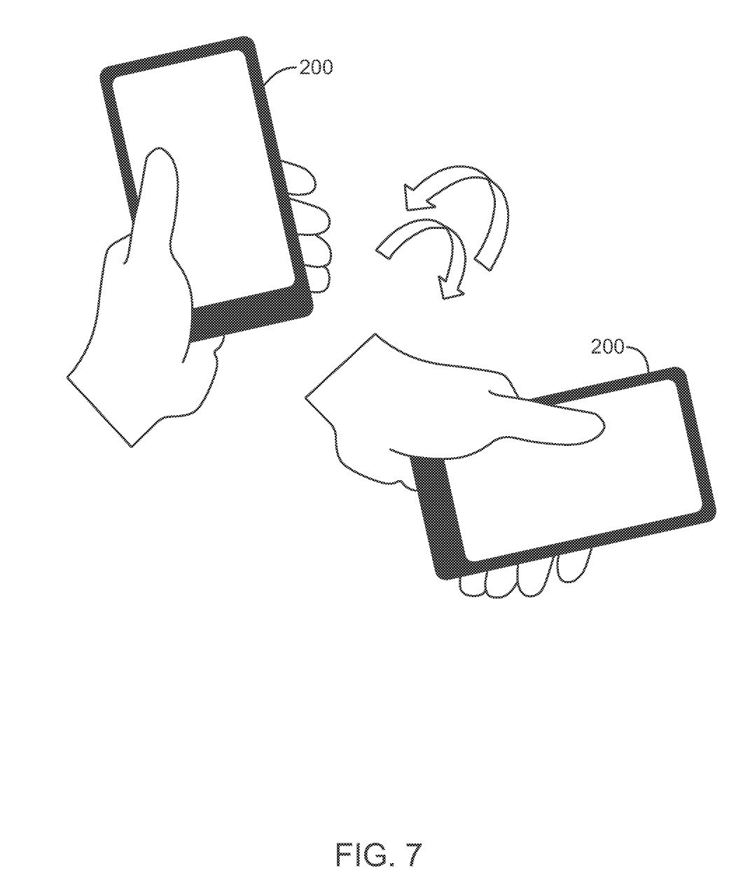

FIG. 7 shows an embodiment of the smart phone 200 in which the user-manipulatable input of the I/O module 110 is a tilt angle sensor, which is embedded within a housing of the smart phone 200. The tilt angle sensor may include an accelerometer, gyroscope, or other suitable sensor. Thus, for example, the logic of the processor 120 can measure time periods corresponding to manipulations of the tilt angle of the smart phone 200 for comparison with the stored reference values.

In one embodiment, the passkey can be entered using a combination of different user-manipulatable inputs, including, for example, a combination of two or more instances of the buttons 210, a combination of the button 210 and the touchscreen 510, a combination of two or more instances of the switch 610, a combination of the button 210 and the switch 610, a combination of the button 210 and the tilt angle sensor, or any other combination of the inputs depicted in FIGS. 3, 5, 6, and 7 or any other inputs not depicted or mentioned above. For example, a first input can be used for a first half of the set of time periods and a second input can be used for a second half of the set of time periods. Alternatively, a first input can be used for even numbered time periods in the sequence of time periods and a second input can be used for odd numbered time periods. In one embodiment, a specific combination and sequence of inputs is configurable by a user.

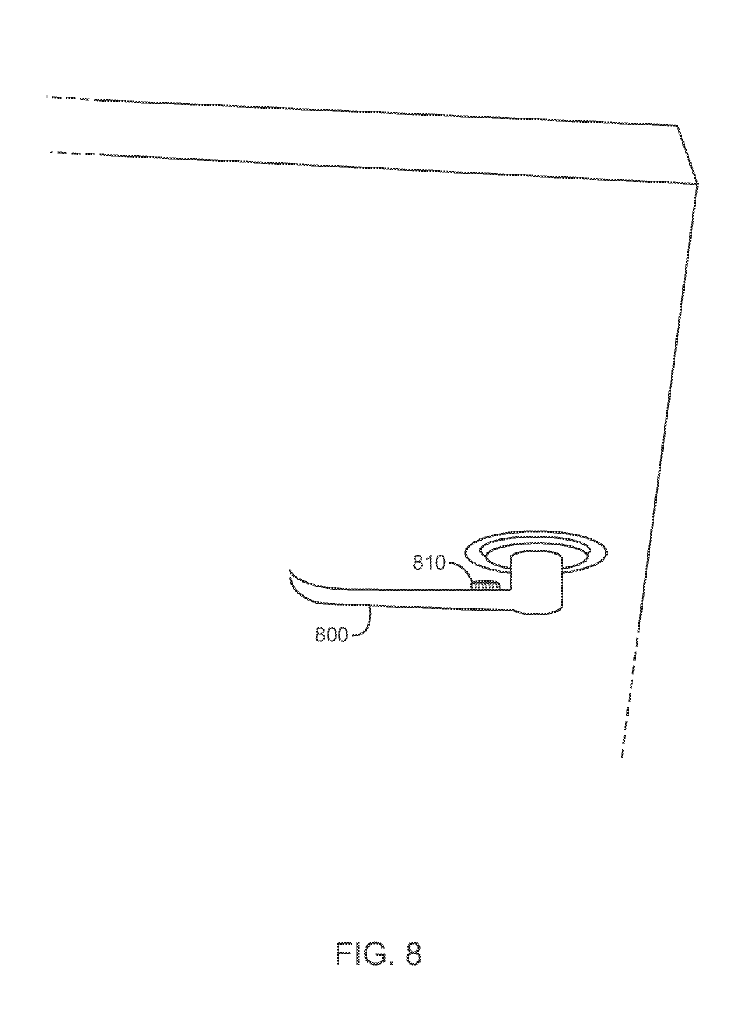

FIG. 8 shows a doorknob 800 as an example form factor of the apparatus 100. The user-manipulatable input of the I/O module 110 is a button 810. The processor 120 and memory 130 are not shown but can be embedded within the doorknob 800 or another portion of the door, or can be wirelessly coupled to receive inputs from the button 810. The button 810 is depicted as being located in a place where a user grasps the doorknob 800 and is at least partially hidden from view by the door. However, the button 810 may be located in other places, such as on a side of the doorknob 800 facing the user, on the door, or on a portion of a wall next to the doorknob. As with the smart phone 200, when a user desires to enter a passkey to unlock the doorknob 800, the user presses and releases the button 810 in a pattern of time periods that corresponds to a pre-programmed set of reference time periods. Logic in the processor 120 measures the time periods of the pattern entered by the user and compares the measured time periods to the set of reference values. If the time periods sufficiently match up with the reference values the user is authenticated and the logic unlocks the doorknob 800 to allow the user to open the door.

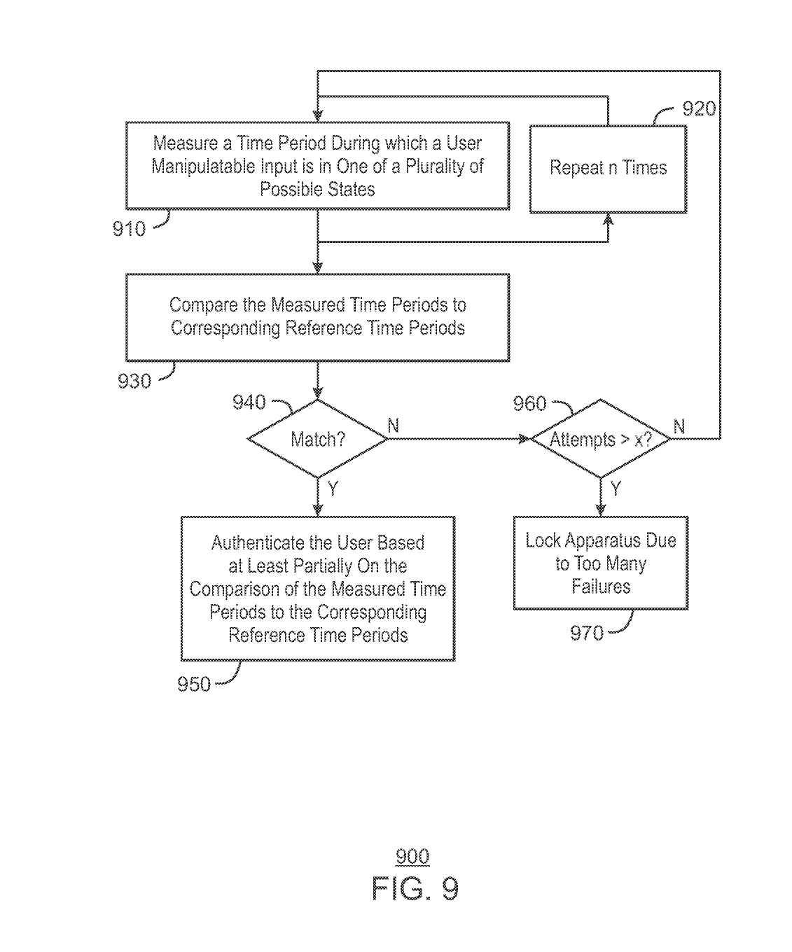

FIG. 9 is a schematic showing a process flow diagram 900 for a no-look one-handed authentication method in accordance with the claimed subject matter. The method 900 may be implemented, for example, by logic in the processor 120 of the apparatus 100 or by logic in a processor remote from the apparatus 100 but in communication with the I/O module 110 of the apparatus 100. The logic at least partially includes hardware logic.

The method includes identifying whether a the user-manipulatable input is in the one of a plurality of possible states for the time period begins at block 910, where an apparatus (such as one of the apparatuses 100 described above) measures a time period (also referred to herein as a measured time) during which a user manipulatable input is in one of a plurality of possible states. The possible states of the button may include, for example, a pressed state and an un-pressed or paused state. Block 910 may be repeated any number of times (designated as “n,” where n is an integer greater than or equal to zero), as indicated by block 920, before the method 900 proceeds to block 930. The number of times of repetition may correspond to a number of reference time periods to which the measured time periods are to be compared. In one embodiment, the number of repetitions at block 920 is zero, meaning the button is pressed only once and authentication is based on a single measured time period.

Then, at block 930, the measured time periods are compared to corresponding reference time periods (also referred to herein as “time periods”). If the measured time periods sufficiently match the corresponding reference time periods, the user is authenticated (block 950). Otherwise, the method 900 proceeds to block 960 to determine whether a predetermined number (designated as “x”, where x is an integer greater than or equal to zero) of passkey entry attempts has been exceeded. If the predetermined number of passkey attempts has not been exceeded, the method 900 proceeds to block 910 to allow re-entry of the passkey. Otherwise, if the predetermined number of attempts is exceeded, the method 900 proceeds to block 970 at which stage the apparatus is locked and does not receive passkey entry attempts, at least temporarily, due to too many passkey entry failures.

The process flow diagram 900 is provided by way of example and not limitation. More specifically, additional blocks or flow diagram stages may be added and/or at least one of the blocks or stages may be modified or omitted. For example, in one embodiment, instead of making a comparison after a series of time periods are measured, a comparison is made between each measured time period and a corresponding reference value before a subsequent time period is measured. Thus, as soon as a measured time period does not match the corresponding reference value, the method proceeds to block 960. Moreover, in another embodiment, a block may be added between block 960 and block 910 to send an output to a display or other output device providing an indication to the user that the passkey entry attempt failed.

Furthermore, measuring time periods in which the button is in the one of the plurality of possible states and comparing the measured time periods to corresponding reference time periods (at blocks 910 and 930) may be accomplished in a variety of ways. For example, one or more programmable countdown timers programmed with the reference time periods may be used, and/or one or more count up timers may be used to measure the time periods during which a button is held and released. Thus, where the number of repetitions is zero at block 920, the measuring and comparing of time periods at blocks 910 and 930 may be generalized as identification of whether a button (or other user-manipulatable input) is in one of a plurality of possible states for a time period. And, in that case, authentication of the user is based on the identification that the button is in the one of the plurality of possible states for the time period.

Embodiments of the invention are not restricted to the particular details listed herein. Indeed, those skilled in the art having the benefit of this disclosure will appreciate that many other variations from the foregoing description and drawings may be made within the scope of the present inventions. For example, in one embodiment, the authentication methods described herein are used in combination with other authentication methods. For example, the no-look one-handed authentication methods described in the foregoing embodiments may be used in addition to a conventional authentication method to provide extra security. Alternatively, the no-look one-handed authentication methods may be selected during an installation or configuration stage as one of a variety of different available authentication methods, the others being conventional authentication methods. In addition, the foregoing no-look one-handed authentication methods can be combined with a mode selector method to facilitate simultaneously authenticating a user and configuring the apparatus to enter a specific mode corresponding to the entered passkey. For example, if the apparatus implementing authentication is a smart phone, one passkey can correspond to a first mode in which the apparatus is unlocked and immediately dials a first designated contact and a second passkey can correspond to a second mode in which the apparatus is unlocked and immediately dials a second designated contact. Alternatively, the apparatus may be a computing device and different passkeys can be used to authenticate and call up different applications upon completion of passkey entry.

Accordingly, it is the following claims including any amendments thereto that define the scope of the inventions.

What is claimed is:

1. An apparatus to facilitate authentication, the apparatus comprising:
logic, the logic at least partially including hardware logic, the logic to:
identify whether a user-manipulatable input is in one of a plurality of possible states for a time period; and
authenticate a user based at least partially on identification that the user-manipulatable input is in the one of the plurality of possible states for the time period.

2. The apparatus of claim 1, wherein the user-manipulatable input includes a button and the plurality of possible states includes a state in which the button is pressed and another state in which the button is not pressed.

3. The apparatus of claim 1, wherein the user-manipulatable input includes a switch and the plurality of possible states includes a plurality of different positions into which the switch can be distinguishably manipulated.

4. The apparatus of claim 1, wherein the user-manipulatable input includes a tilt angle sensor and the plurality of possible states includes a plurality of different tilt angles at which the tilt angle sensor can be distinguishably manipulated.

5. The apparatus of claim 1, wherein the apparatus is part of a system that includes one of: a computing device, a vehicle, at least a portion of a door, and a financial transaction apparatus.

6. The apparatus of claim 1, wherein the logic is to identify whether the user-manipulatable input is in another one of the plurality of possible states for another time period, and
wherein the logic does authentication of the user further based at least partially on identification that the user-manipulatable input is in the other one of the plurality of possible states for the another time period.

7. The apparatus of claim 1, wherein the logic is to identify whether another user-manipulatable input is in one of a plurality of possible states for another time period, and
wherein the logic does authentication of the user further based at least partially on identification that the other user-manipulatable input is in the one of the plurality of possible states for the another time period.

8. The apparatus of claim 1, wherein the logic is to:
measure a time during which a user-manipulatable input is in one of a plurality of possible states; and
compare the measured time to the time period to identify whether the user-manipulatable input is in the one of a plurality of possible states for the time period.

9. The apparatus of claim 8, wherein the logic is to tolerate a difference between the measured time and the time period that is within a tolerance limit when the logic identifies whether the user-manipulatable input is in the one of a plurality of possible states for the time period.

10. The apparatus of claim 1, wherein the time period is re-configurable.

11. A non-transitory computer-readable medium, having instructions thereon to cause a processor to perform operations, the operations comprising:
identify whether a user-manipulatable input is in one of a plurality of possible states for a time period; and
authenticate a user based at least partially on identification that the user-manipulatable input is in the one of the plurality of possible states for the time period.

12. The non-transitory computer-readable medium of claim 11, wherein the user-manipulatable input includes a button and the plurality of possible states includes a state in which the button is pressed and another state in which the button is not pressed.

13. The non-transitory computer-readable medium of claim 11, wherein the user-manipulatable input includes a switch and the plurality of possible states includes a plurality of different positions into which the switch can be distinguishably manipulated.

14. The non-transitory computer-readable medium of claim 11, wherein the user-manipulatable input includes a tilt angle sensor and the plurality of possible states includes a plurality of different tilt angles at which the tilt angle sensor can be distinguishably manipulated.

15. The non-transitory computer-readable medium of claim 11, wherein the processor is part of a system that includes one of: a portable communications device, a vehicle, at least a portion of a door, and a financial transaction apparatus.

16. The non-transitory computer-readable medium of claim 11, wherein the operations further comprise:
identify whether the user-manipulatable input is in another one of the plurality of possible states for another time period,
wherein authentication of the user is further based at least partially on identification that the user-manipulatable input is in the other one of the plurality of possible states for the another time period.

18. The non-transitory computer-readable medium of claim 11, wherein the operations further comprise:
identify whether another user-manipulatable input is in one of a plurality of possible states for another time period,
wherein the logic does authentication of the user further based at least partially on identification that the other user-manipulatable input is in the one of the plurality of possible states for the another time period.

19. The non-transitory computer-readable medium of claim 11, wherein to identify whether the user-manipulatable input is in one of a plurality of possible states for the time period the operations further comprise:
measure a time during which the user-manipulatable input is in the one of a plurality of possible states; and
compare the measured time to the time period.

20. The non-transitory computer-readable medium of claim 19, wherein to compare the measured time to the time period, the operations further comprise:
tolerate a difference between the measured time and the time period that is within a tolerance limit.

21. The non-transitory computer-readable medium of claim 11, wherein the time period is re-configurable.

22. A computing device comprising:
a button;
a display;
logic, the logic at least partially including hardware logic, the logic to:
display information on the display to prompt a user for authentication input;
identify whether the button is in one of a plurality of possible states for a time period; and
authenticate the user based at least partially on identification that the button is in the one of the plurality of possible states for the time period.

23. The computing device of claim 22, wherein the plurality of possible states includes a state in which the button is pressed and another state in which the button is not pressed.

24. The computing device of claim 22, wherein the logic is to identify whether the button is in another one of the plurality of possible states for another time period, and
wherein the logic does authentication of the user further based at least partially on identification that the user-manipulatable input is in the other one of the plurality of possible states for the another time period.

25. The computing device of claim 22, wherein the logic is to identify whether another button is in one of a plurality of possible states for another time period, and
wherein the logic does authentication of the user further based at least partially on identification that the other button is in the one of the plurality of possible states for the another time period.

26. The computing device of claim 22, wherein the logic is to:
measure a time during which a user-manipulatable input is in one of a plurality of possible states;
compare the measured time to the time period; and
identify the user-manipulatable input as being in the one of a plurality of possible states for the time period if a difference between the measured time and the time period is within a tolerance limit.

27. The computing device of claim 22, wherein the time period is re-configurable.

28. The computing device of claim 22, wherein the logic is to display a notification of authentication failure on the display if user is not authenticated.
